(19) United States
(12) Patent Application Publication
(10) Pub. No.: US 2006/0066740 A1
(43) Pub. Date: Mar. 30, 2006

(54) Mobile phone with complete English keyboard

(76) Inventors: Yung-Fa Cheng, Taipei Shien (TW); Hsiang-Lung Kao, Taipei City (TW)

Correspondence Address: RABIN & BERDO, P.C., Suite 500, 1101 14 Street, N.W., Washington, DC, 20005, US

(21) Appl. No.: 11/237,825

(22) Filed: Sep. 29, 2005

(30) Foreign Application Priority Data
Sep. 30, 2004 (TW) 93215545

(51) Int. Cl. H04N 5/335

(52) U.S. Cl. 348/308; 348/372

(57) ABSTRACT

A mobile phone with a complete English keyboard is described. The mobile phone has a front module, a pivot and a rear module. The pivot couples the front module to the rear module. The front module further has a display, a numerical keyboard, an antenna and a battery. The rear module further has an extendable keyboard and an image sensor, e.g. a CCD sensor or a CMOS sensor. The complete English keyboard is composed of the numerical keyboard and the extendable keyboard. The extendable keyboard is revealed to input English and/or Chinese characters by rotating the front module and the rear module around the pivot.

### RELATED APPLICATIONS

The present application is based on, and claims priority from, Taiwan Application Serial Number 93215545, filed Sep. 30, 2004, the disclosure of which is hereby incorporated by reference herein in its entirety.

### FIELD OF THE INVENTION

The present invention generally relates to a mobile phone with double rotational modules. More particularly, the present invention relates to a mobile phone with a complete English keyboard.

### BACKGROUND OF THE INVENTION

Due to great progress in wireless telecommunication technology, the mobile phone has become a personal accessory and can be used almost anytime and anywhere. The mobile phone has thus become an important product for the modern human.

Due to the widespread popularity of mobile phones, mobile phone manufacturers exert much effort in promoting functions for satisfying various users. For example, some mobile phones include personal digital assistant (PDA) functionality, e.g. functions of an address book, appointment scheduler, task list and journal. Some mobile phones further provide video games for users to pass leisure time, and some provide a digital camera for taking pictures anywhere and anytime and enabling users to immediately share the images with friends.

However, the interior space of mobile phones is too tiny to accommodate all these additional functions and associated structures. The dimensions of a mobile phone, generally smaller than a palm, are especially too small to adopt a complete English keyboard. Most mobile phones only include a numerical keyboard for dialing telephone numbers. Users can input English characters by pressing a same numerical key multiple times to select a desired English character. This selecting process on the numerical keyboard is slow because it is tedious and thus wastes a user's time.

Some mobile phone manufacturers design a complete English keyboard on the mobile phone that is convenient for users to input data. However, the conventional complete English keyboard is too small to input data conveniently. Otherwise, the mobile phone needs to be larger in order to accommodate the conventional complete English keyboard.

### SUMMARY OF THE INVENTION

It is an objective of the present invention to provide a mobile phone with a complete English keyboard by utilizing a rotational platform to hide the complete English keyboard behind a display and a numerical keyboard of the mobile phone and reveal the complete English keyboard on demand.

It is another objective of the present invention to provide a mobile phone with a complete English keyboard utilizing a telescopic platform to further shrink the dimensions of the mobile phone.

To accomplish the above objectives, the present invention provides a mobile phone with a complete English keyboard, e.g. a QWERTY keyboard. The mobile phone includes a front module, a pivot and a rear module. The pivot couples the central position of the front module to the central position of the rear module. For using the complete English keyboard, the front module and the rear module are rotated around the pivot until they are perpendicular to each other. Consequently, the complete English keyboard is revealed for users to input data, e.g. English characters, Chinese characters and numerical characters.

The front module further includes a display, a numerical keyboard, an antenna and a battery, and may further include a memory card reader. The rear module further includes an image sensor, e.g. a CCD image sensor or a CMOS image sensor. The complete English keyboard further includes a left keyboard and a right keyboard, and is pushed outwardly by a pushing mechanism.

Hence, the mobile phone with a complete English keyboard provides a fully functional keyboard for inputting data and further provides a telescopic fully functional keyboard to further reduce the size of the mobile phone.

### BRIEF DESCRIPTION OF THE DRAWINGS

The foregoing aspects and many of the attendant advantages of this invention are more readily appreciated as the same becomes better understood by reference to the following detailed description, when taken in conjunction with the accompanying drawings, wherein:

FIG. 1A is a schematic front view of a preferred embodiment of a mobile phone with a complete English keyboard according to the present invention;

FIG. 1B is a schematic rear view of the preferred embodiment of FIG. 1A;

FIG. 1C is a schematic side view of the preferred embodiment of FIG. 1A;

FIG. 2A is a schematic front view of the preferred embodiment of FIG. 1A after the rear module and the front module are rotated around the pivot; and

FIG. 2B is a schematic front view of the preferred embodiment of FIG. 1A when the complete English keyboard is fully extended outward.

### DETAILED DESCRIPTION OF THE PREFERRED EMBODIMENT

The following description is of the best presently contemplated mode of carrying out the present invention. This description is not to be taken in a limiting sense but is made merely for the purpose of describing the general principles of the invention. The scope of the invention should be determined by referencing the appended claims.

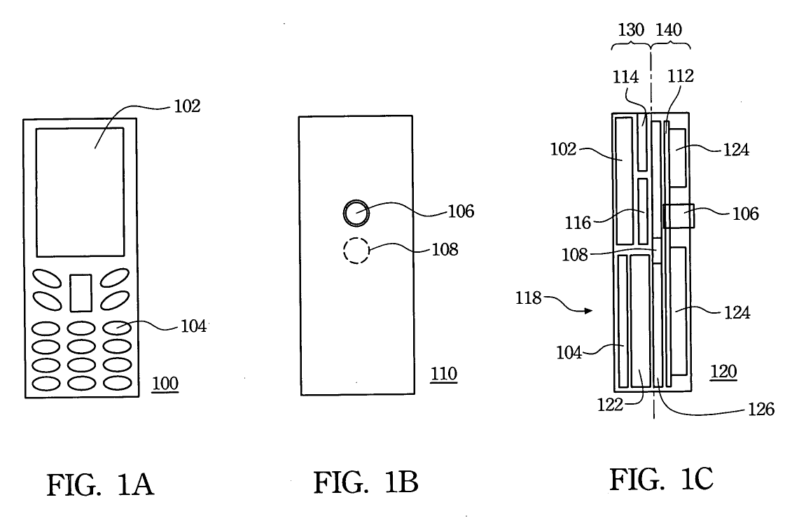

FIG. 1A is a schematic front view of a preferred embodiment of a mobile phone with a complete English keyboard, e.g. a QWERTY keyboard, according to the present invention. FIG. 1B is a schematic rear view and FIG. 1C is a schematic side view of the preferred embodiment.

Referring to FIGS. 1A through 1C, in the schematic front view 100, a display 102 and a numerical keyboard 104 are configured on a mobile phone. In the schematic rear view 110, an image sensor 106, such as a CMOS image sensor or a CCD image sensor, is configured on the mobile phone. A pivot 108 illustrated with a dotted line provides the rotational function for revealing an extended keyboard from the mobile phone.

Referring to the side view 120, the mobile phone includes a front module 130 with the display 102 and the numerical keyboard 104, and a rear module 140 with the extendable keyboard 126. The complete English keyboard 118, e.g. a QWERTY keyboard, is composed of the numerical keyboard 104 and the extendable keyboard 126. The front module 130 further includes an antenna 114, a memory card reader 116 and a battery 122. The rear module 140 further includes the image sensor 106, a circuit board 112 of the mobile phone and the electronic component 124 installed on the circuit board 112. The circuit board 112 can further support the extendable keyboard 126 of the mobile phone to enhance the rigidity of the extendable keyboard 126.

The mobile phone utilizes the pivot 108 to hide the extendable keyboard 126 in the rear module 140 such that the dimensions of the mobile phone are similar to a mobile phone without the extendable keyboard 126. When a user needs to input data with the complete English keyboard 118, the rear module 140 can be rotated to reveal the extendable keyboard 126. Accordingly, the user can conveniently input characters with the complete English keyboard 118.

Because the complete English keyboard 118 has all the standard character keys, users can quickly input data similar to inputting data with a computer keyboard. The rotatable complete English keyboard 118 according to the present invention can therefore enhance the input efficiency for the mobile phone, especially compared to the input with the conventional numerical keyboard.

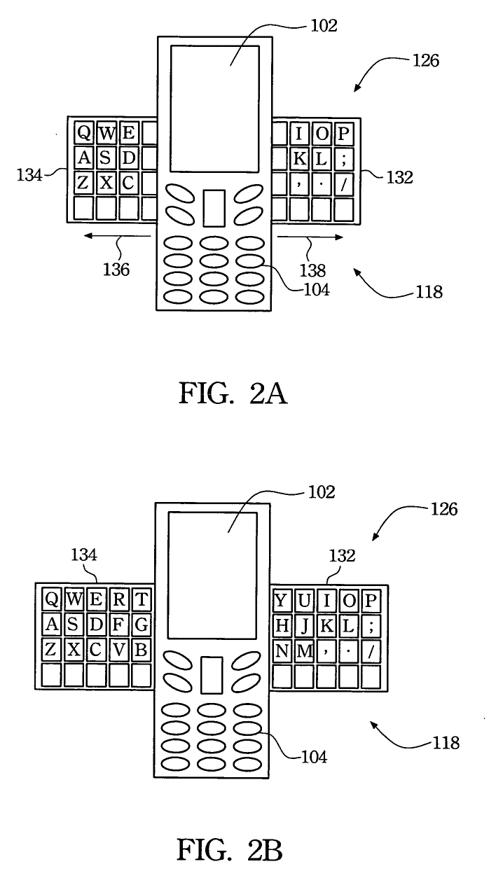

FIG. 2A illustrates the complete English keyboard of the preferred embodiment as rotated around the pivot; and FIG. 2B illustrates the complete English keyboard of the preferred embodiment as fully extended. The extendable keyboard 126 of the complete English keyboard 118 behind the front module 130 is revealed when the rear module 140 is rotated about 90 degrees. At this time, in conjunction with the numerical keyboard 104, the mobile phone according to the present invention has enough keys to represent all 26 English characters, Arabic numerals 0˜9 and some function keys. Accordingly, users can easily input characters including capital and the lowercase letters.

Referring to FIG. 2B, the mobile phone according to the present invention may further provide an extension function for the extendable keyboard 126 of the complete English keyboard 118. When the rear module 140 of the mobile phone is rotated about 90 degrees, the extendable keyboard 126 can further extend outwardly with a pushing mechanism. Therefore, a right keyboard 132 is extended toward a direction 138 of FIG. 2A and a left keyboard 134 is extended toward a direction 136 of FIG. 2A.

Consequently, the usable area of the extendable keyboard 126 is extended so as to accommodate more keys thereon and further shrink the dimension of the mobile phone when the keyboard is retracted. Hence, users can input data with the complete English keyboard 118 on a small mobile phone as the extendable keyboard 126 is extended.

The mobile phone with the complete English keyboard utilizes a rotational platform to hide the extendable keyboard behind the display and the numerical keyboard when not in use, and reveal the extendable keyboard on demand. The mobile phone can further effectively integrate the numerical keyboard with the rotatable keyboard to provide a complete English keyboard for inputting all English characters, numbers and even Chinese characters. The telescopic keyboard design can further shrink the size of the mobile phone.

As is understood by a person skilled in the art, the foregoing preferred embodiments of the present invention are illustrative of the present invention rather than limiting of the present invention. It is intended that various modifications and similar arrangements be included within the spirit and scope of the appended claims, the scope of which should be accorded the broadest interpretation so as to encompass all such modifications and similar structures.

What is claimed is:

1. A mobile phone with a complete English keyboard, comprising:
a front module;
a pivot coupling to the front module; and
a rear module coupling to the pivot, wherein the rear module further comprises an extendable keyboard and the extendable keyboard is revealed after the rear module and the front module are rotated around the pivot.

2. The mobile phone of claim 1, wherein the front module further comprises a display and a numerical keyboard.

3. The mobile phone of claim 1, wherein the front module further comprises an antenna and a battery.

4. The mobile phone of claim 1, wherein the front module further comprises a memory card reader.

5. The mobile phone of claim 1, wherein the rear module further comprises an image sensor.

6. The mobile phone of claim 5, wherein the image sensor is a CCD image sensor or a CMOS image sensor.

7. The mobile phone of claim 1, wherein the extendable keyboard further comprises a left keyboard and a right keyboard.

8. The mobile phone of claim 7, further comprising a pushing mechanism to push the left keyboard and the right keyboard outwardly.

9. The mobile phone of claim 1, wherein the complete English keyboard is composed of the numerical keyboard and the extendable keyboard.

10. A mobile phone with a complete English keyboard, comprising:
a front module further comprising a display and a numerical keyboard;
a pivot coupling to a central position of the front module; and
a rear module, a central position of the rear module coupling to the pivot, wherein the rear module further comprises an extendable keyboard and the extendable keyboard is revealed after the rear module and the front module are rotated around the pivot.

11. The mobile phone of claim 10, wherein the front module further comprises an antenna and a battery.

12. The mobile phone of claim 10, wherein the front module further comprises a memory card reader.

13. The mobile phone of claim 10, wherein the rear module further comprises an image sensor.

14. The mobile phone of claim 13, wherein the image sensor is a CCD image sensor or a CMOS image sensor.

15. The mobile phone of claim 10, wherein the extendable keyboard further comprises a left keyboard and a right keyboard.

16. The mobile phone of claim 15, further comprising a pushing mechanism to push the left keyboard and the right keyboard outwardly.

17. The mobile phone of claim 10, wherein the complete English keyboard is composed of the numerical keyboard and the extendable keyboard.

18. A mobile phone keyboard for inputting English characters on a mobile phone, the mobile phone keyboard comprising:
a numerical keyboard coupling the a front module of the mobile phone;
a left keyboard and a right keyboard coupling to a rear module of the mobile phone and coupling to the front module with a pivot; and
a pushing mechanism pushing the left keyboard and the right keyboard outwardly when the rear module and the front module are rotated around the pivot.

19. The mobile phone keyboard of claim 18, wherein the mobile phone keyboard is a QWERTY keyboard composed of the numerical keyboard, the left keyboard and the right keyboard.
